(19) United States
(12) Patent Application Publication
(10) Pub. No.: US 2010/0216021 A1
(43) Pub. Date: Aug. 26, 2010

(54) ELECTRODE PLATE

(76) Inventor: Rhodri Evans, Monmouthshire (GB)

Correspondence Address: MYERS BIGEL SIBLEY & SAJOVEC, PO BOX 37428, RALEIGH, NC, 27627, US

(21) Appl. No.: 12/664,484

(22) PCT Filed: Jun. 18, 2008
(86) PCT No.: PCT/GB2008/002084

§ 371 Date: Apr. 30, 2010

(30) Foreign Application Priority Data
Jun. 19, 2007 (GB) 0711872.2
Jun. 19, 2007 (GB) 0711873.0
Jan. 15, 2008 (GB) 0800680.1
Jan. 15, 2008 (GB) 0800681.9

(51) Int. Cl. H01M 4/02

(52) U.S. Cl. 429/211

(57) ABSTRACT

An electrode plate (Ib) for a lead acid battery comprises an electrode material supported on a metal support in which the metal support comprises a body portion and a tab portion (4c) which extends from the periphery of the body portion. The body portion comprises a region of grid (2b) and a conduction rail (3c, 3d) which has at its widest part a width of at least 5 mm and which extends in a direction generally parallel to the direction in which the tab portion (4c) extends from the periphery of the body portion. Preferably, the metal support comprises two conduction rails (3c, 3d) which are tapered in opposite directions.

The present invention relates to an electrode plate, to a metal support for the electrode plate and to a battery comprising the electrode plate.

Conventionally, electrode plates in lead acid batteries comprise an active material supported on a metal support grid. Typically the electrode plate is generally rectangular and is provided along one edge with a tab which projects from the metal support grid and is welded to the metal strap which connects the electrodes to the appropriate terminal on the surface of the battery. The metal support carries the electrode material, provides some strength, support, and improves current flow from the active electrode material to the strap.

One known process for preparing conventional electrode plates involves pasting an active material onto a continuous strip of metal support grid which may be many metres long, cutting or punching electrodes from the pasted strip and curing and drying the electrode active material. The continuous strip of metal support grid may be prepared by a) continuous casting of a metal strip having a grid pattern; b) punching holes into a continuous metal strip which has been made, for example, by continuously casting a blank strip or by rolling an ingot, or c) making a predetermined pattern of cuts in a continuous metal strip and then expanding the strip in a transverse direction to give an expanded metal strip. Once the strip has been pasted, finishing operations such as trimming and shaping the tab to the desired size may then be performed. Another known process, known as the book mould process, involves casting individual metal supports which are then pasted with the electrode material. The pasted supports are then cured and dried and any necessary finishing operations performed.

Supports for larger plates, for example, plates having a length of 200 mm or more have conventionally been made by the book mould process although that process has also found application in the manufacture of smaller plates, for example, 50 mm plates. Those metal supports typically have a metal frame which extends around the periphery of the plate to improve strength and current flow and are typically thicker, for example, having a thickness of around 3 to 7 mm or so, than metal supports prepared by cutting or punching from a continuous metal grid.

There is a desire to provide electrode plates having improved current flow. Moreover, the metal of the metal support represents a significant part of the overall cost of the lead acid battery and therefore there is a desire to reduce the amount of metal in the metal support whilst at the same time maintaining the performance of the metal support at an acceptable level.

In a first aspect, the invention provides an electrode plate for a lead acid battery comprising an electrode material supported on a metal support prepared using a book moulding process, a continuous casting process or a punched strip process, the metal support comprising a body portion and a tab portion which extends from the periphery of the body portion and in which the body portion comprises a region of discontinuous metal and at least one conduction rail which has at its widest point a width of at least 5 mm and which extends in a direction generally parallel to the direction in which the tab portion extends from the periphery of the body portion.

The term “continuous casting process” as used herein refers to a process in which a metal support is cast as a continuous strip having one or more regions of grid formed by the casting process, unless another meaning is clear from the context. The term “punched strip process” as used herein refers to a process in which a continuous metal support is formed by punching holes in a continuous strip of blank metal to form one or more grid regions therein. The continuous strip of blank metal may in turn have been formed, for example, by cold rolling a metal ingot or by continuously casting a strip of blank metal.

In a second aspect, the invention provides an electrode plate for a lead acid battery comprising an electrode material supported on a metal support comprising:
i) a generally square or rectangular region of metal grid; and
ii) two conduction rails, each conduction rail extending along an opposing side of the region of metal grid and each having a tab portion at one end and a tapering portion which tapers in a direction away from the tab portion and in which the two conduction rails are arranged such that their tapering portions taper in opposite directions.

The body portion of the metal support in the processes of the first and second aspects of the invention preferably also includes metal cross bars extending transversely across the strip, as described below.

In a third aspect, the invention provides an electrode plate for a lead acid battery comprising an electrode material supported on a metal support comprising a body portion and a tab portion which extends from the periphery of the body portion and in which the body portion comprises a region or regions of discontinuous metal, at least one cross bar and at least one conduction rail which has at its widest part a width of at least 5 mm and which extends in a direction generally parallel to the direction in which the tab portion extends from the periphery of the body portion.

In a fourth aspect, the invention provides an electrode plate for a lead acid battery comprising an electrode material supported on a metal support comprising:
i) one or more generally square or rectangular regions of metal grid;
ii) two conduction rails, each conduction rail extending along an opposing side of the region of metal grid and each having a tab portion at one end and a tapering portion which tapers in a direction away from the tab portion and in which the two conduction rails are arranged such that their tapering portions taper in opposite directions, and
iii) one or more cross bars extending orthogonally from the conduction rails.

In a fifth aspect, the invention provides an electrode plate for a lead acid battery comprising an electrode material supported on a metal support which comprises a body portion and a tab portion which extends from the periphery of the body portion and in which the body portion comprises a region of discontinuous metal and at least one conduction rail which extends in a direction substantially parallel to the direction in which the tab portion extends from the periphery of the body portion.

The or each conduction rail is an elongate metal member which acts as a conduit for electrical current travelling from the region of discontinuous metal, for example, a grid region which supports the electrode material, toward the end of the electrode plate from which the tab portion projects. In that way the current flow characteristics of the electrode plate may be improved in comparison to an electrode plate having no conduction rail. The conduction rail will generally have a width (in the plane of the metal support and perpendicular to the length of the conduction rail) which is greater than its thickness (in a direction perpendicular to the plane of the metal support). The conduction rails of the electrode plate of the present invention are therefore broader and capable of carrying more current than the rectangular frame members which have typically been provided around the periphery of electrode plates made by the book mould process. Preferably, the conduction rail comprises an elongate region of blank metal which at least at one point along its length has a width which is at least two times, more preferably at least four times its thickness. In a preferred embodiment, the conduction rail is an elongate region of blank metal which has a tab portion at one end and a tapering portion which tapers in a direction away from the tab portion.

The conduction rail extends in a direction substantially parallel to the direction in which the tab portion extends from the body portion. The conduction rail may be substantially coaxial with the tab portion and the expression “substantially parallel” should be understood to include “substantially coaxial”. Alternatively, the tab portion may be offset from the conduction rail.

The body portion of the electrode plate carries the electrode material. The body portion may be of any suitable shape. Preferably, the body portion is square or rectangular, most preferably rectangular. Preferably, the or each conduction rail extends along an edge of the body portion. In a preferred embodiment, the body portion is substantially rectangular and the or each conduction rail extends along the respective long edge of the body portion.

The tab portion may of any shape suitable for connection, for example, by welding, to a current carrying member such as a lead strap. In a preferred embodiment, the tab portion is substantially rectangular. The tab portion may extend from a central region of an edge of the body portion. Optionally, the tab portion extends from a corner region of the body portion. The invention encompasses electrode plates in which the tab portion does not extend directly from the end of the conduction rail, for example, in which the conduction rail extends along a long side of a rectangular electrode plate and the tab portion extends from a central region of a short edge of the electrode plate. However, in a preferred embodiment the or each tab portion extends from an end of the or each conduction rail.

Optionally, the conduction rail has a width (perpendicular to its length and in the plane of the metal support) of at least 3 mm, preferably at least 5 mm, more preferably at least 7 mm and in some cases at least 10 mm at a point mid-way along its length. Optionally, the conduction rail has a width (perpendicular to its length and in the plane of the metal support) which is no more than 40 mm, preferably no more than 30 mm.

Optionally, the metal support has one conduction rail. Alternatively, the metal support may have two or more conduction rails. In a preferred embodiment, the body portion of the metal support has two conduction rails arranged generally parallel to each other. In a highly preferred embodiment two conduction rails are each arranged along a long edge of a rectangular body portion.

The term “cross bar” as used herein refers to a region of blank metal which extends from the conduction rail transversely across the body portion of the metal support. Where the body portion comprises two or more conduction rails, the cross bar will connect the two conduction rails together, thereby improving the flow of current in the electrode. The inclusion of cross bars in the metal support may improve overall plate conductivity and may therefore allow a reduction in the width of the conduction rail or rails, thereby optimising the ratio of active paste to inert metal. Preferably, the or each cross bar is substantially orthogonal to the conduction rail or rails. The cross bars will advantageously have a width in the range of from 2 to 10 millimetres, preferably in the range of from 2 to 5 millimetres. Optionally, the cross bars may be tapered so that the width changes progressively in a direction orthogonal to the conduction rail. Where the cross bars are tapered, the width of the cross bars at the narrowest point is preferably at least 2 millimetres and is more preferably in the range of from 2 to 5 millimetres.

Optionally, the body portion of the metal support includes one or more cross bars. Preferably, the body portion includes two or more cross bars, and optionally three or more cross bars. Where the body portion includes more than one cross bar, the cross bars are preferably spaced at a regular interval along the length of the conduction rail or rails. Preferably, the regular interval is in the range of from 30 mm to 400 mm. Preferably, the body portion includes at least one cross bar which is bounded on both sides by grid regions and which does not extend along an edge of the metal support.

The invention provides in a preferred embodiment an electrode plate for a lead acid battery comprising an electrode material supported on a metal support which comprises a tab portion and a body portion which comprises a region of discontinuous metal and at least one conduction rail which extends along an edge of the region of discontinuous metal and has a tapering portion which tapers in a direction away from the tab portion.

In the electrode plate of the invention the conduction rail performs the dual purpose of strengthening at least part of the edge of the region of discontinuous metal and providing a path by which current may flow during discharging or charging of the battery between the tab portion and the electrode material, thereby improving the current flow within the plate. The provision of a tapering portion in the conduction rail which tapers in a direction away from the tab portion so that the width of the conduction rail at a location which is distant from the tab portion is less than the width at a location which is proximate to the tab portion makes possible a reduction in the amount of metal used in the conduction rail as compared to a conduction rail which does not taper. As the amount of current carried by the conduction rail will in general increase along the conduction rail in a direction towards the tab portion the tapering of conduction rail away from the tab portion makes a more efficient use of the metal of the conduction rail as compared to a conduction rail which does not taper.

The electrode plate may be anode plate or a cathode plate and the electrode material may be any material suitable as an active material in an anode or cathode of a lead acid battery. Suitable electrode materials will be known to the skilled person.

In a preferred embodiment, the metal support comprises two conduction rails which are arranged generally parallel to each other such that their tapering portions taper in opposite directions. In that arrangement the tab portions will extend in opposite directions such that current may be collected from opposite ends of the electrode plate. In a particularly preferred embodiment, the tapers of the tapering portions of the two electrode plates are matched such that at any position along the length of the electrode plate the sum of the thicknesses of the tapering portions remains the same such that the current carrying capacity of the two conduction rails together remains approximately equal along the plate. Optionally, the metal support also includes one or more cross bars which extend form one conduction rail to the other.

The tab portion of the metal support may be of any suitable shape for joining the metal support to a current collecting member such as a metal strap which is arranged to collect current from the plates of the battery. In a preferred embodiment, the tab portion is rectangular. The tab portion will extend from the periphery of the plate, preferably at or near a corner of the plate. Preferably, the tab portion has a width (as measured in a direction parallel to the edge of the body portion from which the tab extends) in the range of from 0.5 cm to 4 cm. Preferably, the tab portion extends from the edge of the body portion by a length in the range of from 0.75 cm to 4.0 cm.

The electrode plate may be any suitable shape. For example, the electrode plate may be generally square or generally rectangular. Preferably, the electrode plate is generally rectangular. Where the electrode plate is generally rectangular the metal support will desirably comprise two conduction rails each extending along a respective long edge of the electrode plate such that the tab portions extend from diagonally opposing corners of the electrode plate and the tapering portions of the conduction rails taper in opposite directions.

Optionally, the or each conduction rail extends over only a part of the respective edge of the region of discontinuous metal. The or each conduction rail preferably extends along at least 70% of the length of the respective side of the region of discontinuous metal and more preferably extends along the full length of the respective side of the region of discontinuous metal. Especially preferably, the tapering portion of the or each conduction rail extends along substantially the entire length of the respective edge of the region of discontinuous metal.

As mentioned above, the conduction rail may be of any suitable shape or configuration. For example, it may be generally straight or curved, it may be a flat plate or it may be profiled. Preferably, the conduction rail is an elongate area of flat, continuous metal. The angle of taper of any tapering portion optionally varies along the length of the tapering portion and the tapering portion may include regions of no taper such as where the tapering portion reduces in width in a stepwise fashion. The word “taper” and the expression “tapering portion” should be construed broadly to include such variations. The important thing is that where the conduction rail tapers the width of the conduction rail decreases over the length of the conduction rail. Preferably, however, the taper of the tapering portion is constant along the length of the tapering portion such that the width of the tapering portion decreases steadily along its length in a direction away from the tab portion. Preferably, the conduction rail is an elongate member having two long straight sides which gradually approach one another in a direction away from the tab portion.

At the end of the conduction rail distal from the tab portion the width of the tapering portion may diminish to zero. Alternatively, the end of the tapering portion distal from the tab portion may have a finite width which is preferably in the range of from 1 to 10 mm, more preferably in the range of from 1 to 5 mm. The width of the tapering portion of the conduction rail at the end nearest the tab portion may be, for example, in excess of 10 mm and in some cases may be greater than 15 mm. Preferably, the width of the tapering portion at the end proximately tab portion is less than 50 mm, more preferably less than 40 mm. The width of the conduction rail optionally decreases along the length of the tapered portion by 50% or more, preferably by 70% or more and optionally by 90% or more.

The region of discontinuous metal may be of any suitable shape but will preferably be generally rectangular. The region of discontinuous metal optionally accounts for between 50 and 95% of the area of the metal support. The discontinuities of the discontinuous metal may be of any suitable shape or configuration which is suitable for providing a framework upon which the active electrode material paste can be supported. Preferably, the region of discontinuous metal is a region of metal grid, particularly a grid comprising regularly spaced rectangular apertures. Preferably, the grid is a rectilinear grid. Such grids are well known to the skilled person for use as metal supports in electrode plates for lead acid batteries.

The conduction rail may have a thickness which is the same as or different to the thickness of the region of discontinuous metal. Where the metal support has been cut or punched from a strip of continuous metal support material, it will be convenient for the conduction rail and the region of continuous metal to have the same thickness (although in some cases it will be desirable to subsequently reduce the thickness of the tab portions, for example, by grinding). The metal support preferably has a thickness in the range of 0.5 to 5 mm, preferably 0.8 to 4 mm and more preferably from 1 to 3 mm.

It may be desirable for the conduction rail to have a thickness which is greater than that of the region of discontinuous metal, especially where the metal support has been made by the book mould process. For example, the conduction rail may have a thickness in the range of from 3 to 7 mm.

The electrode plate may be an anode or a cathode. The electrode plate may have any desired length. In a preferred embodiment, the electrode plate has a length of at least 100 mm, preferably at least 250 mm. The electrode plate is optionally no longer than 1300 mm. Advantageously, the electrode plate has a width in the range of from 100 mm to 600 mm.

The electrode plate optionally has a thickness in the range of from 0.4 mm to 8 mm, optionally in the range of from 0.6 mm to 8 mm, for example, in the range of from 1 mm to 5 mm.

The electrode material is preferably present across the full area of both faces of the metal support excluding the or each tab portion.

Optionally, the metal support includes in addition to the tapering conduction rails one or more further regions of continuous metal which improve the current flow within the electrode plate. For example, the tapering conduction rails may be integral with a rectangular frame extending around the periphery of a rectangular electrode plate, especially where the metal support has been made by the book mould process.

The metal support may be of any suitable metal. Preferably, the metal support is of lead or a lead alloy. The electrode plate optionally includes further components, for example, the electrode plate may include on each face an outer covering such as a paper material which prevents the electrode material of different electrode plates sticking together during the manufacturing process.

The electrode plate of the invention may be incorporated in a battery using conventional assembling methods. For example, a number of electrodes may be assembled into an electrode plate stack of alternating positive and negative electrodes. In such a stack, the plates are aligned so that the tabs of the negative plates are aligned in a row or rows and the tabs of the positive plates are also aligned in a row or rows parallel to the negative plate tabs. The plate stack is then inverted and lead straps are cast onto the rows of tabs. The stack is then inserted into a battery box and a lid welded on top.

In a further aspect, the invention provides a lead acid battery comprising at least one electrode plate according to any aspect of the invention. Preferably, all the electrode plates of the lead acid battery are electrode plates according to the invention.

In one embodiment, the electrode plate of the invention has one or more tabs located at or close to a corner of the electrode plate. In the finished battery those tab portions will be very close to the side wall of the battery container and it will therefore be necessary to adapt the container and lid accordingly. In a preferred embodiment, the lid of the battery container contains one or more metal inserts, each insert having one or more apertures and each aperture being shaped to accommodate a plate tab such that the plate tabs enter the apertures as the lid is fitted onto the battery. Before the fitting of the lid, the tabs are welded to the metal inserts. The metal inserts include means for attaching a cable and act as the battery terminals. Such a battery is described in our co-pending patent application GB 0619444.3 filed 2 Oct. 2006 and is particularly well suited to accommodating electrodes in which the plate tabs are very close to a side wall of the battery.

Optionally, the battery is a two volt battery. Alternatively, the battery may a multicell battery having a higher voltage, for example, 6 or 12 volts. The invention is applicable to a wide range of lead acid battery technologies, for example, absorbent glass mat (AGM) valve regulated or gelled electrolyte batteries, or flooded technology.

The electrode plate of the invention may be made by any suitable process. In one embodiment, the electrode plate is made by a process involving casting a metal support via the book mould process and then pasting the electrode material onto the support. Alternatively, the electrode plate of the invention may be prepared by a process which involves providing a long strip of metal support material and cutting or punching the electrode plate from that long strip. The electrode plate of the invention may be prepared by a process in which, contrary to common practice, the electrode portions are cut such that their length is in a longitudinal direction with respect to the strip of metal support material. In that process, the or each conduction rail can be cut from selvedge rails which extend along the edges of the strip of the metal support material. In the second, third, fourth and fifth aspects of the invention, the electrode plate is optionally made by a process involving cutting and expanding a metal strip, pasting electrode material onto the expanded strip and then cutting or punching the electrode plates from the pasted strip.

Embodiments of the invention will now be described for the purpose of illustration only with reference to the following figures in which:

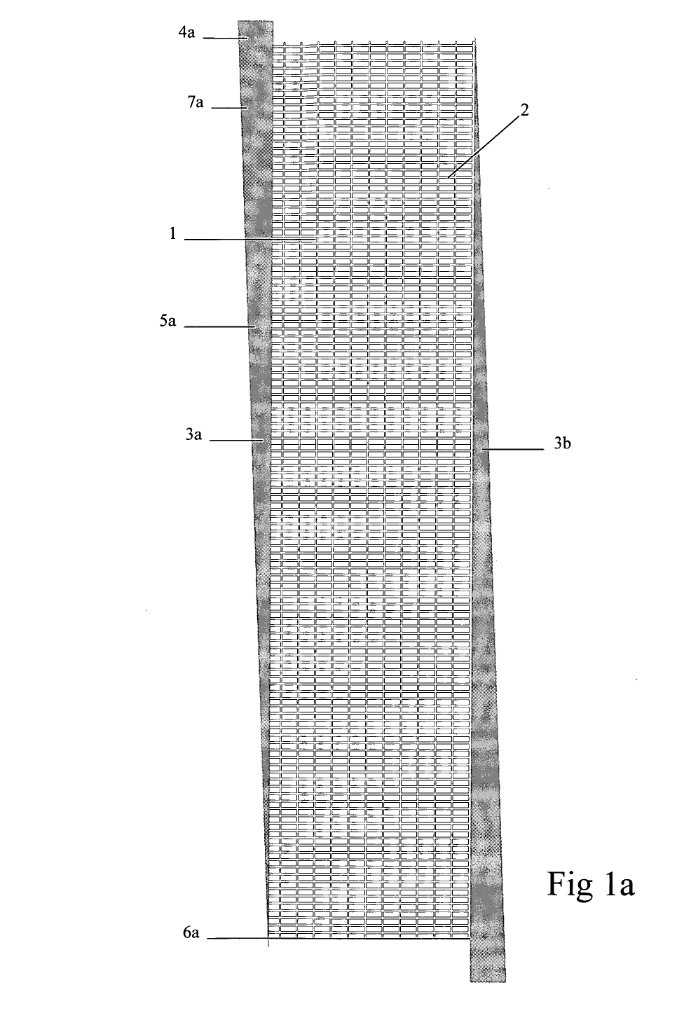

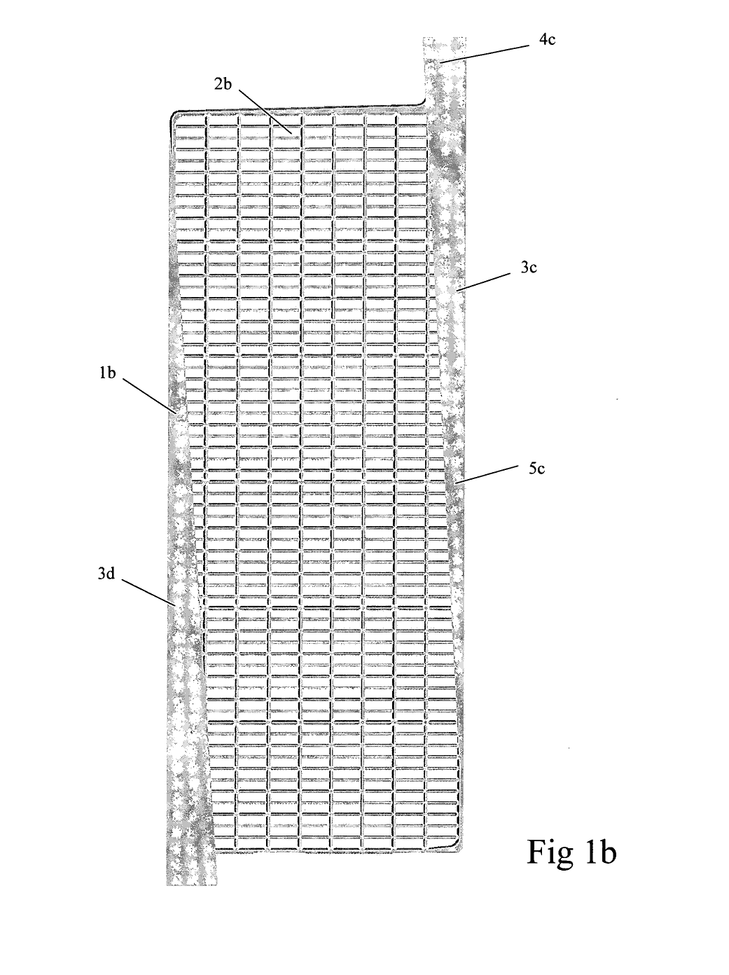

FIGS. 1a and 1b shows electrode plates according to the invention;

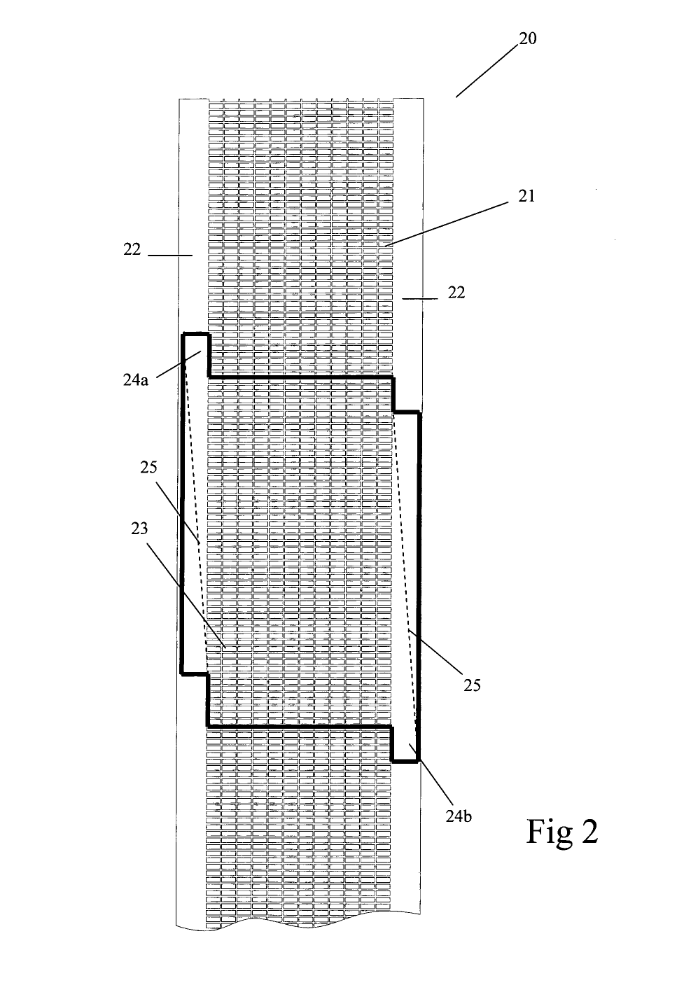

FIG. 2 shows a strip of metal support material showing in outline a portion to be punched out during the manufacture of an electrode plate according to the invention;

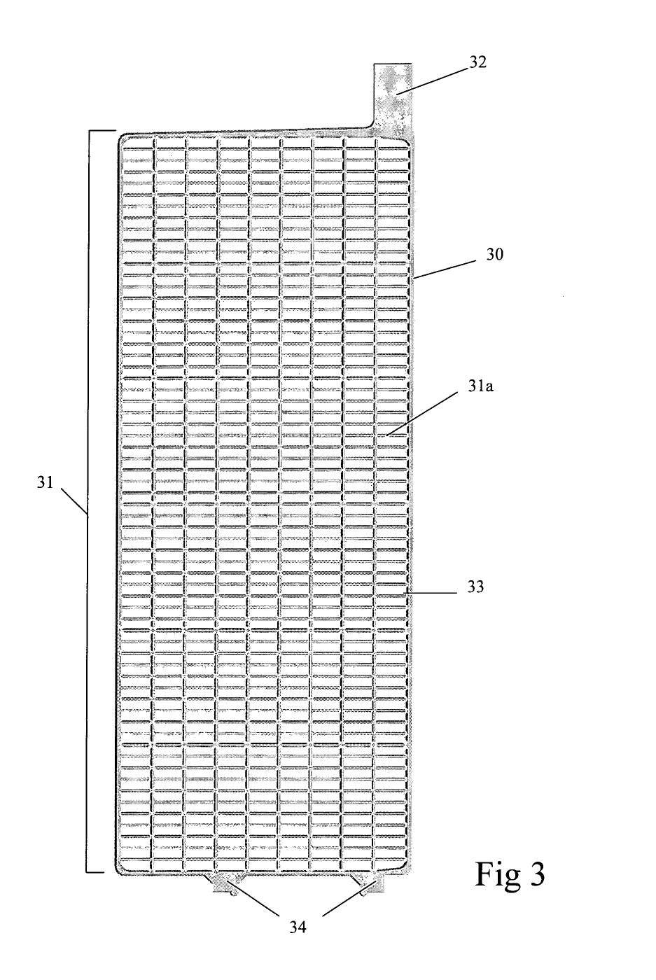

FIG. 3 shows a metal support of a conventional type, manufactured by the book mould process;

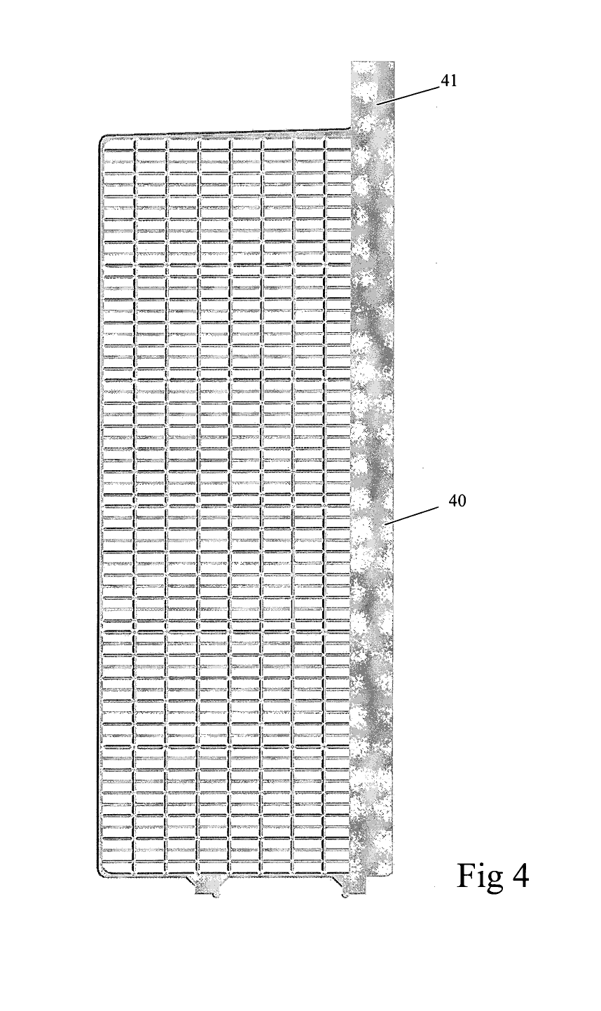

FIG. 4 shows a metal support for an electrode according to the invention manufactured by the book mould process;

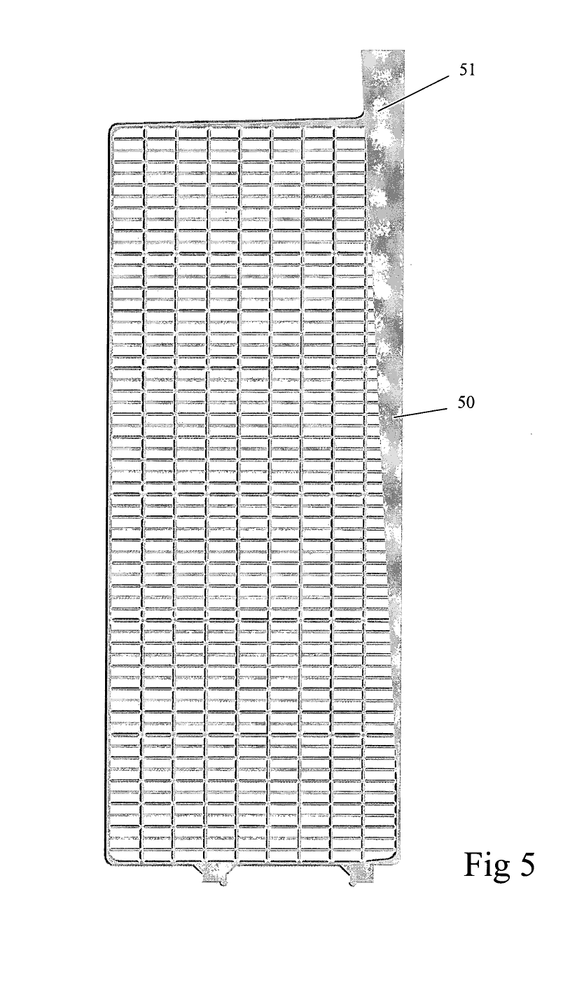

FIG. 5 shows a further embodiment of a metal support manufactured by the book mould process for an electrode plate according to the invention; and

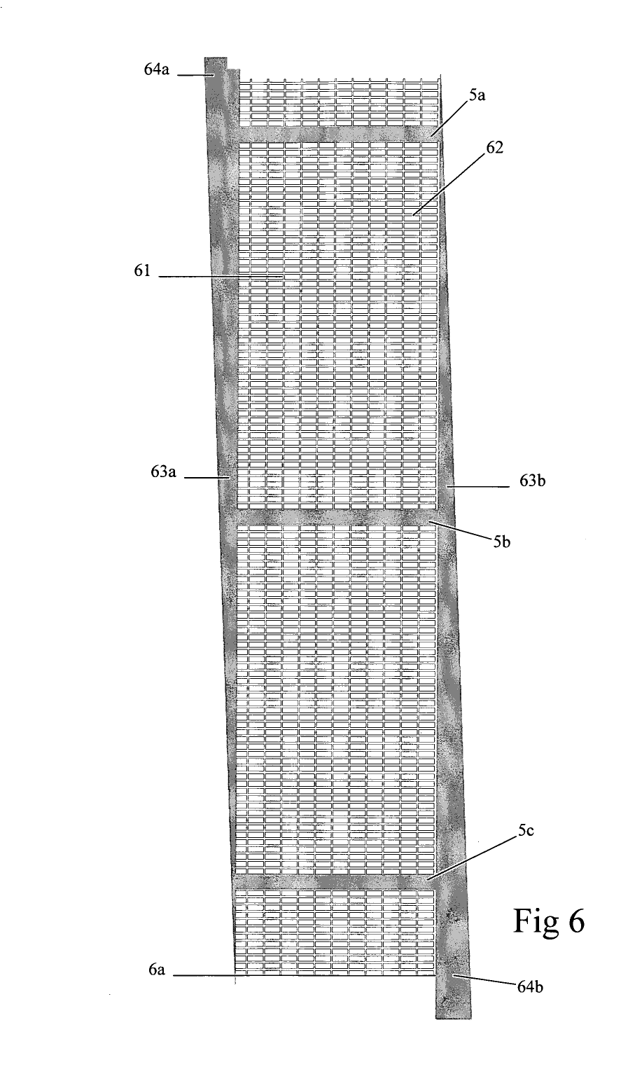

FIG. 6 shows an electrode plate similar to that shown in FIG. 1a having cross bars.

FIG. 1a shows an electrode plate 1 according to the invention (the electrode material is not shown for reasons of clarity). As can be seen, the electrode plate 1 is generally rectangular and comprises a metal support having a region of discontinuous metal in the form of a rectangular area of metal grid 2 which has on each of its long sides a conduction rail 3a and 3b. The rectangular area of metal grid and the two conduction rails together constitute the body portion of the metal support. The grid region 2 allows the electrode material (not shown) to key into the metal support. The conduction rail 3a is generally straight and elongate and a tab portion 4a projects from one end. The tab portion 4a is generally rectangular and extends from a corner of the electrode plate 1 in a direction generally parallel to the length of the conduction rail. In the assembly of the battery, the tab portion 4a will be welded into a lead strap which is in turn connected to a terminal post on the exterior of the battery. The conduction rail 3a also comprises a tapering portion 5a which is integral with and extends from the tab portion along the full length of the long side of the grid region 2. As can be seen from FIG. 1a, the tapering portion 5a tapers at a constant rate along its length in a direction away from the tab portion 4a such that at the distal end 6a of the conduction rail the width of the conduction rail approaches zero whereas at the proximate end 7a of the tapering portion the width of the conduction rail is equal to the width of the tab portion 4a.

Conduction rail 3b is identical to conduction rail 3a but is arranged such that it tapers in the opposite direct to conduction rail 3a. As can be seen from FIG. 1a, the sum of the width of conduction rails 3a and 3b is generally constant along the length of the electrode plate 1. Moreover, the width of each conduction rail is greatest in the region where it carries most current, i.e. the region proximate to the tab portion and is smallest in the region it carries the least current, i.e. at the end distal from the plate tabs.

FIG. 1b shows an electrode plate 1b (the electrode material is not shown for reasons of clarity) which is generally similar to the electrode plate shown in Figure la except that it has a metal support which has been made by the book mould process. That metal support has a rectangular area of metal grid 2b which has on each of its long sides a conduction rail 3c and 3d. The conduction rail 3c comprises a tab portion 4c and a tapering portion 5c. Conduction rail 3d is similar to conduction rail 3c, but is arranged in the opposite direction.

FIG. 2 shows a section of a long strip of metal support material 20. Strip 20 has a central region of metal grid 21 which is bounded at each edge by a selvedge rail 22. Those selvedge rails 22 are elongate regions of continuous metal. FIG. 2 also shows the outline of an electrode plate 23 according to the present invention which is to be cut out of the long strip 20. As can be seen from FIG. 2, the electrode plate 23 is orientated on the metal support strip 20 with its length running longitudinally along the strip. The electrode plate 23 is generally rectangular with two tab portions 24a and 24b extending from diagonally opposite corners. Electrode plates 23 are cut from adjacent parts of the strip along the length of the strip thereby minimising waste. The selvedge rails 22 are also trimmed along the dotted lines 25 shown in FIG. 2 either at the same time as the electrode plate 23 is cut from the strip or at a subsequent stage. In that way the selvedge rails are trimmed such that they taper away from the tab portions 24a and 24b thereby forming the conduction rails of the electrode plate of the invention.

FIG. 3 shows a conventional metal support manufactured by the book mould process.

The metal support 30 includes a body portion 31 and a rectangular tab portion 32, the body portion 31 includes a region of rectangular grid 31a upon which in the finished electrode the electrode material is supported. Extending around the periphery of the grid region is a metal frame 33 which is approximately 2.5 mm wide and which provides some strength to the body portion. At the bottom edge of the metal support there are two false lugs 34 which are provided for processing regions and which will be removed prior to installation of the plate in a battery.

FIG. 4 shows a further metal support prepared by a book mould process which generally corresponds to the support shown in FIG. 3 except that it is provided along one long edge with a conduction rail 40 which consists of an elongate region of blank metal. The conduction rail 40 extends from and is generally parallel to the tab portion 41. In the finished electrode plate, the conduction rail 40 will act as a conduit for current travelling from the metal grid to the tab portion 41.

FIG. 5 shows a metal support for an electrode plate according to the invention which is similar to that shown in FIG. 4 except that the conduction rail 50 is tapered in a direction away from the tab portion 51.

The metal supports shown in FIGS. 4 and 5 could also, for example, have two conduction rails each, preferably located on opposite long sides of the rectangular body portion and two tab portions extending from each short edge of the rectangular body portion. In a further variant, the tab portion 51 and 41 could extend from a central region of the short edge rather than from a corner region of the short edge. In that variation, it may be desirable to provide a connection member between the end of the conduction rail and the tab portion in order to provide a current flow conduit between the two.

FIG. 6 shows an electrode plate 61 which is generally similar to the electrode plate shown in FIG. 1a. The electrode plate 61 includes electrode material (not shown for reasons of clarity) supported on a metal support having a central grid portion 62 and two conduction rails 63a and 63b which extend along each of the long sides of the grid region 62. Each of the conduction rails 63a and 63b has a tab portion Ma and 64b at one end and a tapering portion which tapers in a direction away from the tab portion. Extending from conduction rail 63a to conduction rail 63b are three cross bars 5a, 5b and 5c. Those cross bars, which, like the grid portion 62 and the conduction rails 63a and 63b, are part of the metal support, improve both the strength and rigidity of the electrode plate and the current flow within the electrode plate. As shown in FIG. 6, the cross bars 5a, 5b and 5c as substantially orthogonal to the conductional rails 63a and 63b. Each conduction rail 5a, 5b, 5c has a width of 6 mm (as measured in the long direction of the electrode plate 61). The cross bars 5a, 5b and 5c are spaced at a regular interval of 150 mm along the length of the plate. The body portion of the metal support of the electrode plate 61 comprises the grid portion 62, the cross bars 5a, 5b, 5c and the parts of the conduction rails 63a and 63b which border directly onto the grid portion 62. The tab portions of the metal support constitute tabs 64a and 64b.

In an alternative embodiment, the cross bars 5a, 5b and 5c do not have a constant width and instead taper across the width of the electrode plate, that is, they are wider at one conduction rail than at the other.

Variations of the above-mentioned embodiments will readily occur to the skilled person. For that reason for the purpose of ascertaining the true extent of the invention regard should be had to the appended claims.

1-41. (canceled)

42. An electrode plate for a lead acid battery comprising an electrode material supported on a metal support, the metal support being prepared using a book moulding process, a continuous casting process or a punched strip process and comprising a body portion and a tab portion which extends from the periphery of the body portion, and the body portion comprising a region of discontinuous metal and a conduction rail which has at its widest point a width of at least 5 mm and which extends in a direction generally parallel to the direction in which the tab portion extends from the periphery of the body portion.

43. An electrode plate as claimed in claim 42 in which the body portion of the metal support is substantially square or rectangular and the conduction rail extends along one edge of the body portion.

44. An electrode plate as claimed in claim 43 in which the body portion is substantially rectangular and the conduction rail extends along a long edge of the body portion.

45. An electrode plate as claimed in claim 42 in which the tab portion extends from the end of the conduction rail.

46. An electrode plate as claimed in claim 42 in which the conduction rail has a width of at least 3 mm at a point mid-way along its length.

47. An electrode plate as claimed in claim 42 in which the conduction rail has a tapering portion which tapers in a direction away from the tab portion.

48. An electrode plate as claimed in claim 47 which comprises two conduction rails arranged generally parallel to each other which taper in opposite directions.

49. An electrode plate as claimed in claim 47 in which the taper of the tapering portion is constant along the length of the tapering portion.

50. An electrode plate for a lead acid battery comprising an electrode material supported on a metal support comprising:
i) a generally square or rectangular region of metal grid; and
ii) two conduction rails, each conduction rail extending along an opposing side of the region of metal grid and each having a tab portion at one end and a tapering portion which tapers in a direction away from the tab portion and in which the two conduction rails are arranged such that their tapering portions taper in opposite directions.

51. An electrode plate for a lead acid battery comprising an electrode material supported on a metal support comprising a body portion and a tab portion which extends from the periphery of the body portion and in which the body portion comprises a region or regions of discontinuous metal, at least one cross bar and a conduction rail which has at its widest part a width of at least 5 mm and which extends in a direction generally parallel to the direction in which the tab portion extends from the periphery of the body portion.

52. An electrode plate as claimed in claim 51 in which the body portion of the metal support is substantially square or rectangular and the conduction rail extends along one edge of the body portion.

53. An electrode plate as claimed in claim 51 in which the tab portion extends from the end of the conduction rail.

54. An electrode plate as claimed in claim 51 in which the conduction rail has a width of at least 3 mm at a point mid-way along its length.

55. An electrode plate as claimed in claim 51 in which the conduction rail has a tapering portion which tapers in a direction away from the tab portion.

56. An electrode plate as claimed in claim 51 the metal support comprising at least two cross bars and in which the cross bars are spaced at regular intervals along the length of the continuous metal support.

57. An electrode plate as claimed in claim 56 in which the cross bars are spaced at an interval of in the range of from 30 mm to 400 mm.

58. An electrode plate as claimed in claim 51 in which the cross bars have a width in a longitudinal direction with respect to the length of the continuous metal support in the range of from 2 to 10 mm.

59. An electrode plate as claimed in claim 51 in which the metal support has been made by one of the book mould process, by punching and cutting a continuous metal strip and by cutting a continuous cast strip.

60. An electrode plate for a lead acid battery comprising an electrode material supported on a metal support comprising:
i) one or more generally square or rectangular regions of metal grid;
ii) two conduction rails, each conduction rail extending along an opposing side of the region of metal grid and each having a tab portion at one end and a tapering portion which tapers in a direction away from the tab portion and in which the two conduction rails are arranged such that their tapering portions taper in opposite directions, and
iii) one or more cross bars extending orthogonally from the conduction rails.

61. A lead acid battery comprising at least one electrode plate, the electrode plate comprising an electrode material supported on a metal support, the metal support being prepared using a book moulding process, a continuous casting process or a punched strip process and comprising a body portion and a tab portion which extends from the periphery of the body portion, and the body portion comprising a region of discontinuous metal and a conduction rail which has at its widest point a width of at least 5 mm and which extends in a direction generally parallel to the direction in which the tab portion extends from the periphery of the body portion.
